(19) United States
(12) Patent Application Publication
(10) Pub. No.: US 2021/0232969 A1
(43) Pub. Date: Jul. 29, 2021

(54) METHODS AND APPARATUS TO PROCESS A MACHINE LEARNING MODEL IN A MULTI-PROCESS WEB BROWSER ENVIRONMENT

(71) Applicant: Intel Corporation, Santa Clara, CA (US)

(72) Inventor: Ningxin Hu, Shanghai (CN)

(21) Appl. No.: 17/059,986

(22) PCT Filed: Dec. 24, 2018
(86) PCT No.: PCT/CN2018/123216

§ 371 Date: Nov. 30, 2020

(51) Int. Cl. G06N 20/00

(52) U.S. Cl. CPC G06N 20/00

(57) ABSTRACT

Methods, apparatus, systems and articles of manufacture to process a machine learning model in a multi-process web browser environment are disclosed. An example apparatus includes a graph executor to determine a mode of operation for a computation graph to be executed. A central processing unit (CPU) interpreter is to lookup a CPU instruction corresponding to a node of the computation graph, the CPU instruction being a CPU-specific instruction for execution by at least one processor. A graph profiler is to determine whether the computation graph is frequently executed. A graphics processing unit (GPU) compiler interface is to, in response to determining that the computation graph is frequently executed, transmit a request for compilation of at least two nodes of the computation graph into a GPU kernel for execution at a GPU.

### FIELD OF THE DISCLOSURE

This disclosure relates generally to processing of a machine learning model, and, more particularly, to methods and apparatus to process a machine learning model in a multi-process web browser environment.

### BACKGROUND

Nowadays, there is a momentum in the computing industry to deploy the machine learning (ML) workloads, especially deep learning (DL) models, to end-user edge devices, instead of server devices. The advantages of performing computations on edge devices include cost saving, privacy protection, and real-time performance. Machine learning workloads have been more recently provided to end-user edge devices in web browser environment(s). Hardware developers are developing hardware (e.g., central processing units (CPUs), graphics processing units (GPUs), vector processing units (VPUs), etc.,) and/or software (e.g., math kernel library deep neural network (MKL-DNN), compute library for deep neural networks (clDNN), etc.) optimizations to accelerate the DL computation at the edge device which, in some examples, involves offloading computations from a CPU to a GPU or other circuitry. However, web browser based environments make utilization of such optimizations difficult.

### BRIEF DESCRIPTION OF THE DRAWINGS

FIG. 1 is a block diagram of an example computation graph representing an example machine learning model.

FIG. 2 is a block diagram of an example computing system implementing a web browser environment.

FIG. 3 is a block diagram of the example unprivileged instruction executor of FIG. 2.

FIG. 4 is a block diagram of the example privileged instruction executor of FIG. 2.

FIG. 5 is a flowchart representative of machine readable instructions that may be executed to implement the example unprivileged instruction executor of FIGS. 2 and/or 3.

FIG. 6 is a flowchart representative of machine readable instructions that may be executed to implement the example privileged instruction executor of FIGS. 2 and/or 4 to compile a computation graph for execution by the graphics processing unit (GPU) of FIG. 2.

FIG. 7 is a flowchart representative of machine readable instructions that may be executed to implement the example privileged instruction executor of FIGS. 2 and/or 3 to provide compiled instructions to the GPU of FIG. 2 for execution.

FIG. 8 is a block diagram of an example processing platform structured to execute the instructions of FIGS. 5, 6, and/or 7 to implement the example instruction executors of FIGS. 2, 3, and/or 4.

The FIGS. are not to scale. In general, the same reference numbers will be used throughout the drawing(s) and accompanying written description to refer to the same or like parts.

### DETAILED DESCRIPTION

When a user causes a web browser of a computing system to navigate to a web site, the web browser downloads data including, for example, HyperText Markup Language (HTML) documents, cascading style sheet (CSS) documents, JavaScript files, etc. from a web server, executes the JavaScript code, and renders a user interface according to HTML and/or CSS. However, security risks exist such that the web browser may be compromised as a result of executing instructions from a malicious web site. To address this security challenge, modern web browsers (e.g., Google Chrome, Microsoft Edge, Mozilla Firefox, etc.), usually utilize multiple processes within a sandboxing architecture. As such, the web browser typically has two type of processes: unprivileged processes and privileged processes.

An unprivileged process implements a rendering engine and/or a JavaScript engine in a sandboxed environment. As such, the unprivileged process is only allowed to access the CPU to execute instructions, but is not allowed access to one or more of a file system, a display, network and/or devices attached to the computing system.

In contrast, a privileged process is allowed access to system resources, such as a graphics processing unit (GPU). To gain access to such system resources, the unprivileged process communicates with the privileged process using an inter-process-communication (IPC) protocol.

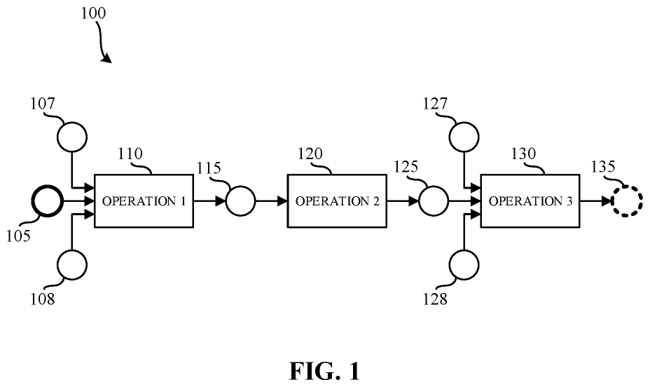

FIG. 1 is a block diagram of an example computation graph 100 representing an example machine learning model. The example computation graph 100 of FIG. 1 is represented as a directed acyclic graph (DAG). The example computation graph 100 includes an input tensor node 105, internal tensors nodes 107, 108, 115, 125, 127, 128, operation nodes 110, 120, 130, and an output tensor node 135. As used herein, a tensor is an n-dimensional array, and may be used to store/represent data (e.g., input data and/or output data). As shown in the illustrated example of FIG. 1, tensor nodes may have different types including input tensor (e.g., a tensor used to supply information for computation to the computation graph), internal tensor (e.g., a tensor used within the computation graph), and output tensor (e.g., a tensor used to provide output information).

In the illustrated example of FIG. 1, the operation nodes 110, 120, 130 represent computations and/or other functions (e.g., convolution, pooling functions, fully-connected functions, etc.) that may be performed on one or more input tensors and/or internal tensors to generate a further internal tensor and/or output tensor. To execute the machine learning model, a framework provides the input tensor data to the computation graph 100, and iterates over the graph to detect and execute any operation node(s) where the input data to the operation node(s) is available. Finally, the output tensor is computed as the output of the computation graph at the output tensor node 135.

In existing approaches, when displaying a web page, an unprivileged process parses HTML and/or CSS files to result in display of the web page. When the web page includes and/or references a script file (e.g., a JavaScript file), the script file is parsed and executed by the unprivileged process. If the script file includes the use of a machine learning model, the unprivileged process loads the machine learning model (e.g., from a network location), and constructs a computation graph representation of the machine learning model. In some cases, the computation graph is prepared for execution by a central processing unit (CPU).

To prepare an operation node for execution, the framework causes CPU binary instructions to be generated (e.g., compiled) and/or identified. For example, if the machine learning model were to utilize a TensorFlow.js framework (which uses JavaScript), a JavaScript engine may perform just-in-time (JIT) compilation to generate a CPU binary instruction. Alternatively, if the machine learning model were to utilize a WebAssembly (WASM) framework, the JavaScript engine directly generates the CPU binary. The CPU hardware is then directed to execute the generated CPU binary and returns the result to unprivileged process. The iteration of the computation graph continues until the output tensor is computed.

In some existing approaches, the computation graph may be executed by a graphics processing unit (GPU). For example, the TensorFlow.js framework utilizes a web graphics library (WebGL) application programming interface (API) to prepare instructions for execution by a GPU. Likewise, a WebDNN framework uses a web graphics processing unit (WebGPU) API. When an unprivileged process identifies an operation node for execution, the unprivileged process loads the GPU source code implementation of that operation and calls the corresponding API to execute the GPU shader source at the GPU. As this is done from an unprivileged process (e.g., a process without direct access to the GPU), the unprivileged process communicates the request to the privileged process. The request is communicated between the unprivileged process and the privileged process using an inter-process communication (IPC) protocol.

In existing systems, as the unprivileged process is not trusted by the privileged process, the request from the unprivileged process it validated. The privileged process validates the request and any provided parameters (e.g., the GPU shader source code). If validation succeeds, the GPU shader source code is provided to the GPU driver for execution by the GPU. After the GPU completes the execution of the GPU shader source code, the result is provided to the privileged process, which then communicates the result back to the unprivileged process. This process is iterated until the output tensor is computed.

Thus, in the context of FIG. 1, if each of the three operations 110, 120, and 130 were to be executed by the GPU, three separate requests to execute an operation, and responses from execution of the operation, would be communicated between the unprivileged process and the privileged process. Thus, existing approaches result in significant communications overhead.

Moreover, the CPU execution of existing systems is not optimized. As JavaScript and WebAssembly are designed for general mathematics computation and cross-CPU architecture, the JavaScript engine cannot generate CPU(s) instruction specifically optimized for tensor operation (e.g., Intel advanced vector extensions (AVX) instructions, vector neural network instructions (VNNI) instruction, etc.).

Likewise, the GPU execution of existing systems is not optimized. For example, existing frameworks (e.g., the WebGL framework, WebGPU shader language, etc.) are designed to be cross-GPU architecture compliant, and the resultant tensor operations are not implemented to take advantage of hardware specific features such as, for example, Intel Open Computing Language (OpenCL) extensions.

Furthermore, in existing systems, the CPU and GPU executions are slow to start. Before achieving a first result, the CPU execution encounters compilation and code-generation overhead. The start of GPU execution is even slower, as such execution involves the overhead of transferring data over an IPC channel. Further, compilation of the GPU shader source code consumes compute time as well.

Example approaches disclosed herein utilize a computation graph CPU interpreter with optimized CPU operation binary code within the unprivileged process of multi-process web browser. Example approaches disclosed herein also utilize a computation graph GPU compilation framework with optimized GPU operation source code implementation for multi-process web browser. Example approaches disclosed herein also utilize a computation graph executor to distribute the execution of a computation graph to CPU interpreter or GPU compilation orchestrator according to graph execution profiling.

Such approaches enable the use of hardware-specific instructions, such as an AVX instruction and an VNNI instruction for CPU execution, and the use of OpenCL extensions for GPU execution. Moreover, example approaches disclosed herein enable a fast start and high sustained speed execution experience for deep learning workloads in web browser environments.

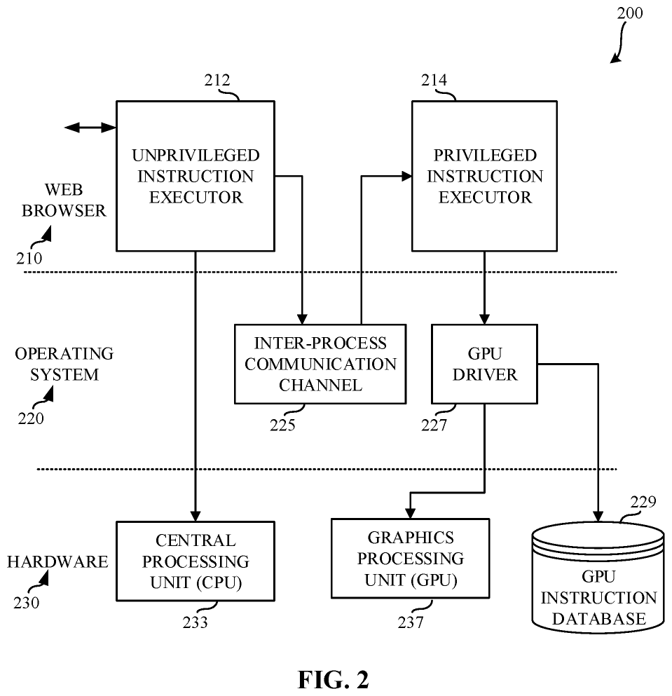

FIG. 2 is a block diagram of an example computing system 200 implementing a web browser environment. The example computing system 200 of the illustrated example of FIG. 2 includes a web browser level 210, an operating system level 220, and a hardware level 230. The example web browser level 210 includes an unprivileged instruction executor 212 and a privileged instruction executor 214. The example operating system level 220 includes an inter-process communication (IPC) channel 225, a GPU driver 227, and a GPU instruction database 229. The example hardware level 230 includes a central processing unit CPU 233 and a graphics processing unit 237.

As noted above, a web browser typically has two types of instruction executors: unprivileged instruction executors and privileged instruction executors. The unprivileged instruction executors commonly implements components (e.g., a rendering engine, a JavaScript engine, etc.) in a sandboxed environment. As such, the unprivileged instruction executor is only allowed to access the CPU to execute instructions, but is not allowed access to one or more of a file system, a display, network and/or devices attached to the computing system.

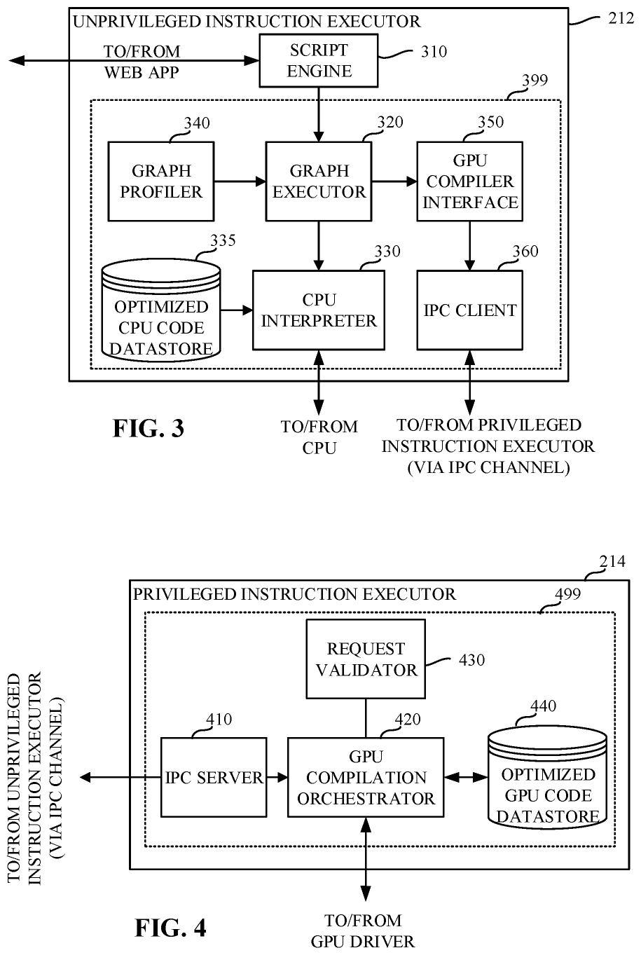

The unprivileged instruction executor 212 of the illustrated example of FIG. 2 is implemented by instructions executed using a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. An example approach to implementing the example unprivileged instruction executor 212 is shown below in connection with FIG. 3. In the illustrated example of FIG. 2, the example unprivileged instruction executor 212 communicates with external resources (e.g., web servers and/or web applications).

In contrast to the unprivileged instruction executor 212, the privileged instruction executor 214 is allowed access to system resources, such as a graphics processing unit (GPU). To gain access to such system resources, the unprivileged instruction executor 212 communicates with the privileged instruction executor 214 using the inter-process-communication (IPC) channel 225.

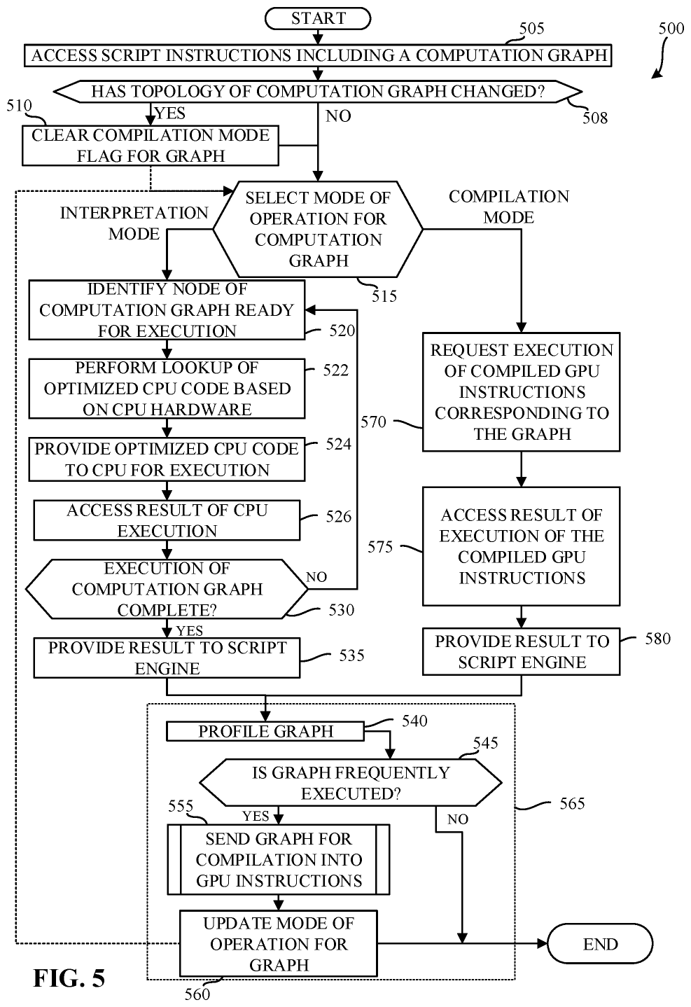

The example privileged instruction executor 214 of the illustrated example of FIG. 2 is implemented by instructions executed using a logic circuit such as, for example, a hardware processor. However, any other type of circuitry may additionally or alternatively be used to execute the instructions implementing the privileged instruction executor 214 such as, for example, one or more analog or digital circuit(s), logic circuits, programmable processor(s), ASIC(s), PLD(s), FPLD(s), DSP(s), etc. An example approach to implementing the example privileged instruction executor 214 is shown below in connection with FIG. 4.

The example inter-process communication (IPC) channel 225 of the illustrated example of FIG. 2 is implemented by instructions executed using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The IPC channel 225 is hosted by the operating system, and enables the unprivileged instruction executor 212 to communicate with the privileged instruction executor 214. While in the examples disclosed herein, IPC is used to enable communications between the unprivileged instruction executor 212 and the privileged instruction executor 214, any other approach to facilitating such communication may additionally or alternatively be used such as, for example, network communications.

The example GPU driver 227 of the illustrated example of FIG. 2 is implemented by instructions executed using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. In examples disclosed herein, the GPU driver 227 facilitates communication between the privileged instruction executor 214 and the GPU 237. The privileged instruction executor 214 provides optimized GPU-specific instructions (e.g., source code) to the GPU driver 227, which compiles the GPU-specific instructions into a GPU-specific kernel (e.g., binary code), and stores the GPU-specific kernel in the GPU instruction database 229 for later execution by the GPU 237.

The example GPU instruction database 229 of the illustrated example of FIG. 2 is implemented by any memory, storage device and/or storage disc for storing data such as, for example, flash memory, magnetic media, optical media, solid state memory, hard drive(s), thumb drive(s), etc. In some examples, the GPU instruction database 229 is implemented at and/or in connection with the GPU 237. Furthermore, the data stored in the example GPU instruction database 229 may be in any data format such as, for example, binary data, comma delimited data, tab delimited data, structured query language (SQL) structures, etc. While, in the illustrated example, the GPU instruction database 229 is illustrated as a single device, the example GPU instruction database 229 and/or any other data storage devices described herein may be implemented by any number and/or type(s) of memories. In the illustrated example of FIG. 2, the example GPU instruction database 229 stores compiled GPU instructions (e.g., kernels) corresponding to computation graphs for execution by the GPU 237.

The example CPU 233 of the illustrated example of FIG. 2 is implemented by hardware. For example, the CPU 233 can be implemented by one or more integrated circuits, logic circuits, microprocessors, etc. capable of executing machine-readable instructions. In some examples, the CPU may be from a particular manufacturer (e.g., Intel) and/or from a particular family of processor devices and, as such, may support execution of device-specific instructions. As a result, execution of some computation graphs in an interpreted mode may be more efficient when using those device-specific instructions.

The example GPU 237 of the illustrated example of FIG. 2 is implemented using a circuit. The GPU 237 executes instructions to modify the contents of a buffer (e.g., a buffer stored in a memory internal to the GPU 237 and/or a memory external to the GPU 237). Typically, the buffer is a frame buffer that is used to output information to a display device (e.g., a monitor). Recently, GPUs have been used for tasks that are not necessarily related to generating output images such as, for example, machine learning tasks. In examples disclosed herein, the GPU 237 executes an instruction package commonly referred to as a kernel and/or a compute kernel that is compiled based on a computation graph. In the illustrated example of FIG. 2, a single GPU is shown. However, some computing systems may utilize multiple GPUs. Moreover, in some examples, the GPU may be implemented in a separate (e.g., remote) computing system.

As noted above, GPUs execute instruction packages commonly referred to as kernels, compute kernels, and/or shaders. Typically, the term shader is used when a kernel is used for graphics-related tasks such as, for example, DirectX, Open Graphics Library (OpenGL) tasks, pixel shader/shading tasks, vertex shader/shading tasks, etc. The term kernel is used for general purpose computational tasks such as, for example, Open Computing Language (OpenCL) tasks, C for Media tasks, etc. While example approaches disclosed herein use the term kernel, such approaches are equally well suited to be used on shaders. In examples disclosed herein, such kernels roughly correspond to a compiled version of a computation graph. As used herein, a GPU kernel refers to a kernel in binary format.

FIG. 3 is a block diagram of the example unprivileged instruction executor 212 of FIG. 2. The example unprivileged instruction executor 212 of the illustrated example of FIG. 3 includes a script engine 310, a graph executor 320, a CPU interpreter 330, and optimized CPU code data store 335, a graph profiler 340, a GPU compilation compiler interface 350, and an IPC client 360. In some examples, the example graph executor 320, the example CPU interpreter 330, the example optimized CPU code data store 335, the example graph profiler 340, the example GPU compiler interface 350, and the example IPC client 360 may be collectively referred to as a web API proxy 399.

The example script engine 310 of the illustrated example of FIG. 3 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example script engine 310 executes scripts as a component of display and/or processing of a web page. In examples disclosed herein, the scripts are provided to the script engine 310 from a network resource (e.g., a remote web-server). In examples disclosed herein, the scripts are JavaScript scripts. However, any other scripting language may additionally or alternatively be used. In some examples, the script(s) executed by the script engine 310 include instructions, functions, and/or other constructs that cause execution of a computation graph to implement a machine learning model.

The example graph executor 320 of the illustrated example of FIG. 3 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. In examples disclosed herein, the graph executor 320 implements a Web API for computation graph execution. The example graph executor 320 relies on the example CPU interpreter 330 or GPU compiler interface 350 for the actual execution of computation graphs.

The example CPU interpreter 330 of the illustrated example of FIG. 3 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example CPU interpreter 330 enables interpreted execution of operation nodes in a provided computation graph. In examples disclosed herein, the CPU interpreter 330 performs a lookup of instructions to be executed in the optimized CPU code data store 335 to identify CPU-specific instructions to be executed based on the operation nodes identified in the computation graph. In this manner, CPU-specific instructions, if available, can be used for executing the computation graph. For example, AVX and/or VNNI instructions may be used for Intel CPUs.

The example optimized CPU code data store 335 of the illustrated example of FIG. 3 is implemented by any memory, storage device and/or storage disc for storing data such as, for example, flash memory, magnetic media, optical media, solid state memory, hard drive(s), thumb drive(s), etc. In some examples, the optimized CPU code data store 335 is implemented locally to the unprivileged instruction executor 212. However, the optimized CPU code data store 335 may be implemented in any other location such as, for example in a file system, in one or more files associated with the web browser layer 210 (e.g., a file that is accessible to the unprivileged instruction executor 212). Furthermore, the data stored in the example optimized CPU code data store 335 may be in any data format such as, for example, binary data, comma delimited data, tab delimited data, structured query language (SQL) structures, etc. While, in the illustrated example, the optimized CPU code data store 335 is illustrated as a single device, the example optimized CPU code data store 335 and/or any other data storage devices described herein may be implemented by any number and/or type(s) of memories. In the illustrated example of FIG. 3, the example optimized CPU code data store 335 stores compiled CPU instructions for execution by the CPU 233. In examples disclosed herein, updates to the optimized CPU code data store 335 are provided as part of an update to the browser implemented by the web browser layer 210. However, updates to the optimized CPU code data store 335 may be provided in any other fashion.

The example graph profiler 340 of the illustrated example of FIG. 3 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example graph profiler 340 profiles the execution of a computation graph. In examples disclosed herein, execution statistics for each computation graph executed by the graph executor 320 are recorded in a memory of the graph profiler 340. The graph profiler 340 analyzes the historical executions of computation graph(s) to determine whether a computation graph is frequently executed. If a computation graph is frequently executed, the example graph profiler 340 notifies the graph executor 320 to trigger compilation of the computation graph.

In examples disclosed herein, a computation graph is considered to be executed frequently when it has been executed more than a threshold number of times within a previous threshold time period (e.g., more than twice in the last minute). However, any other factors may be used to determine whether the computation graph is executed frequently and/or, more generally, whether the computation graph should be compiled for future execution by the GPU 237. For example, the size of the computation graph (which may have an impact on the amount of resources used to compile the computation graph), the origin of the computation graph (e.g., whether the computation graph originates from a frequently accessed network resource and/or website), the types of operations included in the computation graph (which may indicate whether compilation is expected to be successful), etc.

The example GPU compiler interface 350 of the illustrated example of FIG. 3 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example GPU compiler interface 350 receives a request from the graph executor to compile and/or execute the operations of a computation graph. As the example GPU compiler interface 350 is a component of the unprivileged instruction executor 212, the example GPU compiler interface 350 relies on the example IPC client 360 to facilitate communications with the privileged instruction executor 214 to compile and/or execute the computation graph.

The example IPC client 360 of the illustrated example of FIG. 3 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example IPC client 360 facilitates communication between the unprivileged instruction executor 212 and the privileged instruction executor 214 via the IPC channel 225. In examples disclosed herein, the IPC client 360 functions as a client (in communication with an IPC server 410 described below in FIG. 4) in a client-server communication relationship. However, any other communication relationship may additionally or alternatively be used. Moreover, in some examples, the IPC client 360 may instead be implemented as a server (and the IPC server 410 of FIG. 4, below, may instead function as a client).

FIG. 4 is a block diagram of the example privileged instruction executor 214 of FIG. 2. The example privileged instruction executor 214 of the illustrated example of FIG. 4 includes an IPC server 410, a GPU compilation orchestrator 420, a request validator 430, and an optimized GPU code data store 440. In some examples, the example IPC server 410, the example GPU compilation orchestrator 420, the example request validator 430, and the example optimized GPU code data store 440 may be collectively referred to as a web API broker 499.

The example IPC server 410 of the illustrated example of FIG. 4 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example IPC server 410 facilitates communication between the unprivileged instruction executor 212 and the privileged instruction executor 214 via the IPC channel 225. As noted above, the roles of the IPC client 360 and the IPC server 410 may, in some examples, be reversed.

The example GPU compilation orchestrator 420 of the illustrated example of FIG. 4 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. The example GPU compilation orchestrator 420 loads GPU source code corresponding to each of the nodes of the computation graph provided by the unprivileged instruction executor 212. That is, the example GPU compilation orchestrator 420 constructs a GPU source code based on the operations that are to be performed as part of the connotation graph. In examples disclosed herein, the source code is retrieved from the optimized GPU code data store 440.

The example GPU compilation orchestrator 420 sends the source code for compilation into a GPU-specific kernel (e.g., binary code) to the GPU driver for compilation. Upon completion of the compilation, the example GPU compilation orchestrator 420 provides an indication of the completion of the compilation to the graph executor 320 via the IPC server 410.

The example request validator 430 of the illustrated example of FIG. 4 is implemented using a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. In examples disclosed herein, the request validator 430 determines whether a request (e.g., a request to compile a computation graph, a request to execute a computation graph, etc.) received from the example unprivileged instruction executor 212 is valid based on parameters provided in the indication of the computation graph to be compiled. In some examples, the parameters may include, for example, a certificate indicating that the request is valid. However, any other approach to validating a request from the unprivileged instruction executor 212 may additionally or alternatively be used.

The example optimized GPU code data store 440 of the illustrated example of FIG. 4 is implemented by any memory, storage device and/or storage disc for storing data such as, for example, flash memory, magnetic media, optical media, solid state memory, hard drive(s), thumb drive(s), etc. In some examples, the optimized GPU code data store 440 is implemented locally to the privileged instruction executor 214. However, the optimized GPU code data store 440 may be implemented in any other location such as, for example in a file system, in one or more files associated with the web browser layer 210 (e.g., a file that is accessible to the privileged instruction executor 214). Furthermore, the data stored in the example optimized GPU code data store 440 may be in any data format such as, for example, binary data, comma delimited data, tab delimited data, structured query language (SQL) structures, etc. While, in the illustrated example, the optimized GPU code data store 440 is illustrated as a single device, the example optimized GPU code data store 440 and/or any other data storage devices described herein may be implemented by any number and/or type(s) of memories. In the illustrated example of FIG. 4, the example optimized GPU code data store 440 stores optimized GPU code that, for example, enables utilization of hardware specific instructions and/or extensions. For example, hardware specific features such as, Intel Open Computing Language (OpenCL) extensions may be utilized on the instructions stored in the optimized GPU code data store 440. In examples disclosed herein, updates to the optimized GPU code data store 440 are provided as part of an update to the browser implemented by the web browser layer 210. However, updates to the optimized GPU code data store 440 may be provided in any other fashion.

While an example manner of implementing the web browser 210 of FIG. 2 is illustrated in FIG. 2, one or more of the elements, processes and/or devices illustrated in FIG. 2 may be combined, divided, re-arranged, omitted, eliminated and/or implemented in any other way. Further, the example script engine 310, the example graph executor 320, the example CPU interpreter 330, the example optimized CPU code data store 335, the example graph profiler 340, the example GPU compiler interface 350, the example IPC client 360, and/or, more generally, the unprivileged instruction executor 212 of FIGS. 2 and/or 3, the example IPC server 410, the example GPU compilation orchestrator 420, the example request validator 430, the example optimized GPU code data store 440, and/or, more generally, the example privileged instruction executor 214 of FIGS. 2 and/or 4 may be implemented by hardware, software, firmware and/or any combination of hardware, software and/or firmware. Thus, for example, any of the example script engine 310, the example graph executor 320, the example CPU interpreter 330, the example optimized CPU code data store 335, the example graph profiler 340, the example GPU compiler interface 350, the example IPC client 360, and/or, more generally, the unprivileged instruction executor 212 of FIGS. 2 and/or 3, the example IPC server 410, the example GPU compilation orchestrator 420, the example request validator 430, the example optimized GPU code data store 440, and/or, more generally, the example privileged instruction executor 214 of FIGS. 2 and/or 4 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example script engine 310, the example graph executor 320, the example CPU interpreter 330, the example optimized CPU code data store 335, the example graph profiler 340, the example GPU compiler interface 350, the example IPC client 360, and/or, more generally, the unprivileged instruction executor 212 of FIGS. 2 and/or 3, the example IPC server 410, the example GPU compilation orchestrator 420, the example request validator 430, the example optimized GPU code data store 440, and/or, more generally, the example privileged instruction executor 214 of FIGS. 2 and/or 4 is/are hereby expressly defined to include a non-transitory computer readable storage device or storage disk such as a memory, a digital versatile disk (DVD), a compact disk (CD), a Blu-ray disk, etc. including the software and/or firmware. Further still, the example script engine 310, the example graph executor 320, the example CPU interpreter 330, the example optimized CPU code data store 335, the example graph profiler 340, the example GPU compiler interface 350, the example IPC client 360, and/or, more generally, the unprivileged instruction executor 212 of FIGS. 2 and/or 3, the example IPC server 410, the example GPU compilation orchestrator 420, the example request validator 430, the example optimized GPU code data store 440, and/or, more generally, the example privileged instruction executor 214 of FIGS. 2 and/or 4 may include one or more elements, processes and/or devices in addition to, or instead of, those illustrated in FIGS. 2, 3, and/or 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

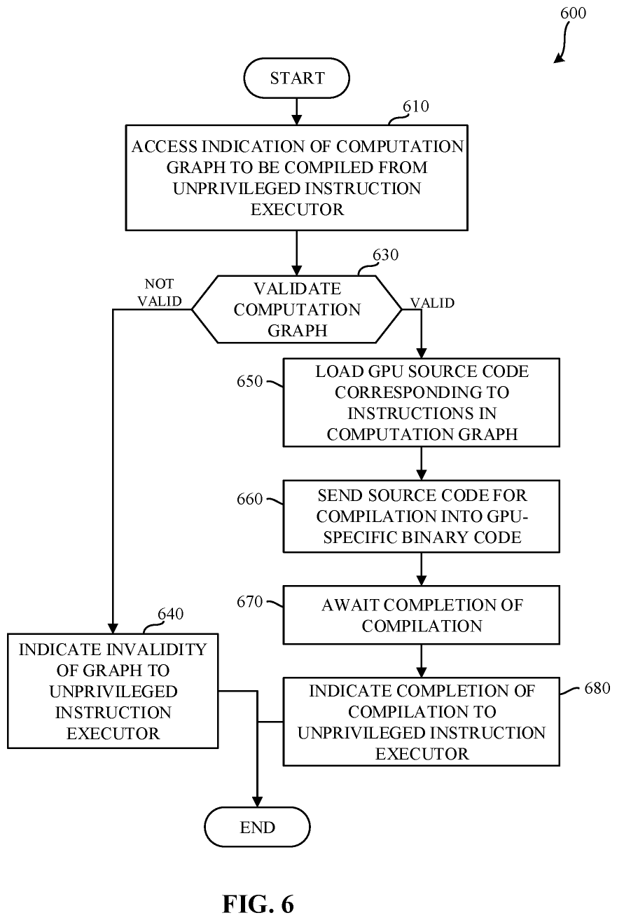

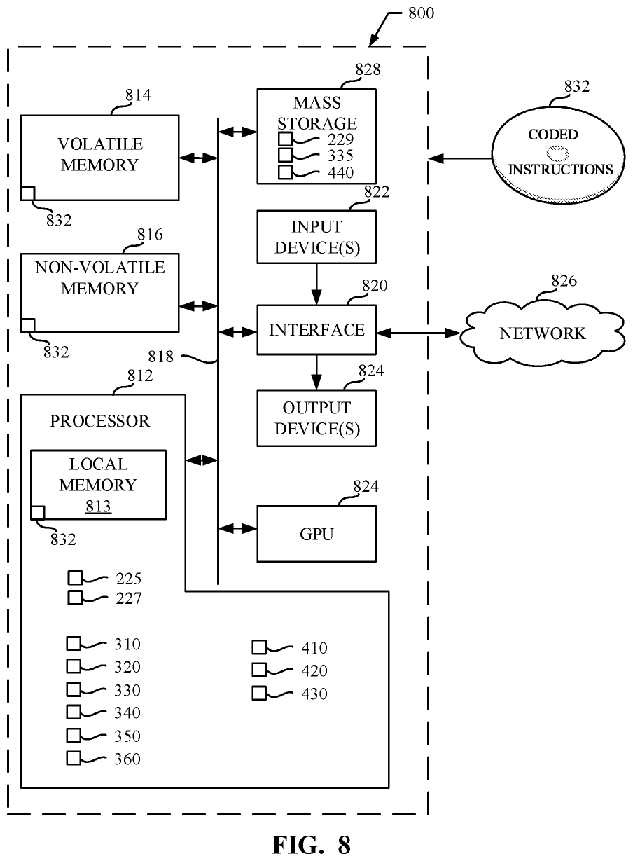

A flowchart representative of example hardware logic, machine readable instructions, hardware implemented state machines, and/or any combination thereof for implementing the unprivileged instruction executor 212 of FIGS. 2 and/or 3 is shown in FIG. 5. Flowcharts representative of example hardware logic, machine readable instructions, hardware implemented state machines, and/or any combination thereof for implementing the privileged instruction executor 214 of FIGS. 2 and/or 4 is shown in FIGS. 6 and/or 7. The machine readable instructions may be an executable program or portion of an executable program for execution by a computer processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIGS. 5, 6, and/or 7, many other methods of implementing the example unprivileged instruction executor 212 and/or privileged instruction executor 214 of FIGS. 2, 3, and/or 4 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 5, 6, and/or 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

FIG. 5 is a flowchart representative of machine readable instructions which may be executed to implement the example unprivileged instruction executor of FIGS. 2 and/or 3. The example process 500 of FIG. 5 begins when the script engine 310 receives a script file for execution that includes a computation graph for execution. The example script engine 310 accesses the script instructions (e.g., JavaScript instructions) that include the computation graph. (Block 505). The example script engine 310 provides the computation graph to the graph executor 320. In examples disclosed herein, the computation graph may be provided, and/or a reference (e.g., a pointer, an identifier) to the computation graph may be provided. In some examples, additional information and/or parameters for execution of the computation graph (e.g., input data) is also provided to the graph executor 320.

In some examples, it is expected that a script may be executed multiple times. As a result, a prior execution of the script may have resulted in the script being compiled for future execution at the GPU (instead of using interpreted execution at the CPU). In such an example, future execution of the computation graph included in the script may be more efficient if executed using the compilation mode. However, if the topology of the computation graph included in the script has changed, such execution using the compilation mode (where such compilation was performed using a different version of the computation graph) may provide an incorrect result. The example graph executor 320 determines whether the topology of the computation graph has changed. (Block 508). In examples disclosed herein, the example graph executor 320 determines whether the topology of the computation graph has changed based on a hash of the computation graph as compared to a prior hash of the computation graph. However, any other approach to determining whether the computation graph has changed may additionally or alternatively be used. If the example graph executor 320 determines that the topology has changed, the example GPU compiler interface 350 clears any prior flags and/or settings indicating that the computation graph is to be executed using the compilation mode. (Block 510).

The graph executor 320 selects a mode of operation for the computation graph. (Block 515). In examples disclosed herein, the example graph executor 320 selects between (1) an interpretation mode, where the instructions of the computation graph are interpreted for execution by the CPU 233, and (2) a compilation mode, where a compiled version of the computation graph is executed by the GPU 237. In examples disclosed herein, the graph executor 320 selects the mode of operation based on whether the computation graph has previously been compiled for execution by the GPU 237 as part of selecting the mode of operation. As noted below, such instructions may be compiled, and a flag may be set indicating the mode of operation to be the compilation mode, in response to that computation graph being frequently executed.

In some examples, other factors may be considered for determining the mode of operation. For example, when a topology of the computation graph is changed at runtime (or at any other time since a prior compilation of the computation graph), the example graph executor 320 may detect such a change and set the mode of operation for that computation graph to the interpretation mode (e.g., in blocks 508, 510). In some examples, the change in the topology of the computation graph may be detected by, for example, comparing a hash of the computation graph to a prior hash of the computation graph (e.g., a hash stored in connection with the compiled version of the computation graph). In examples disclosed herein, if the graph executor 320 is not aware of a compiled version of the computation graph having been previously created, the graph executor 320 defaults to the interpretation mode.

If the example graph executor 320 determines that the interpretation mode is to be used (e.g., Block 515 returns a result of INTERPRETATION MODE), the graph executor 320 identifies a node (e.g., an operation node) of the computation graph that is ready for execution. (Block 520). The example CPU interpreter 330 performs a lookup of the corresponding optimized CPU code in the optimized CPU code data store 335. (Block 522). In examples disclosed herein, the lookup in the optimized CPU code data store is based on the CPU hardware (e.g., the CPU 233) that will perform the execution. As a result, the optimized CPU code does not need to be platform agnostic and can, instead, utilize platform-specific instructions such as, for example, Intel advanced vector extensions (AVX) instructions, vector neural network instruction (VNNI) instructions, etc. The example CPU interpreter 330 provides the optimized CPU code to the CPU 233 execution. (Block 524). The example CPU interpreter 330 accesses a result of the CPU execution. (Block 526). The result is provided to the graph executor 320, which determines whether the execution of the computation graph is complete. (Block 530). If the execution of the computation graph is not complete, control proceeds to block 520 where blocks 520 through 530 are repeated until execution of the computation graph is complete.

Upon completion of the execution of the computation graph, the example graph executor 320 provides the result of the execution (e.g., the output tensor) to the script engine 310. (Block 535).

In some cases, the code to be executed (e.g., the web application) may cause execution of a same computation graph many times. In such an example, it is more efficient for such a computation graph to be executed by a GPU. Execution of instructions by a GPU incurs additional overhead of communicating with the privileged instruction executor as well as compiling such computation graph for execution by the GPU 237. However, when such computation graph is executed frequently, such GPU-based execution can be more efficient. The example graph profiler 340 profiles the execution of the computation graph to determine whether execution is frequent. (Block 540).

In examples disclosed herein, a computation graph is considered to be executed frequently when it has been executed more than a threshold number of times within a previous threshold time period (e.g., more than twice in the last minute). However, any other factors may be used to determine whether the computation graph is executed frequently and/or, more generally, whether the computation graph should be compiled for future execution by the GPU 237. For example, the size of the computation graph (which may have an impact on the amount of resources used to compile the computation graph), the origin of the computation graph (e.g., whether the computation graph originates from a frequently accessed network resource and/or website), the types of operations included in the computation graph (which may indicate whether compilation is expected to be successful), etc.

If the computation graph is executed frequently (block 545 returns a result of YES), the example graph executor 320 sends the computation graph to the example GPU compiler interface 350 for compilation into GPU instructions. (Block 555). An example approach to compiling the computation graph into GPU instructions is described in further detail in connection with FIG. 6, below. The example GPU compiler interface 350 then interfaces with the privilege instruction executor 214 via the IPC client 360 to attempts to compile the computation graph into GPU instructions. Upon successful compilation of the computation graph into GPU instructions, the example GPU compiler interface 350 updates a mode of operation for the computation graph. (Block 560). As a result, future requests to execute the computation graph will, instead of using the interpretation mode, use the compilation mode (e.g., at block 515).

In the illustrated example of FIG. 5, the profiling and compilation of the computation graph into GPU instructions is performed serially upon completion of the execution of the computation graph in the interpretation mode. However, in some examples the profiling and/or compilation of the computation graph into compile GPU instructions (e.g., box 565) may be performed in parallel with the execution of the computation graph in the interpretation mode and/or may be performed asynchronously. Using asynchronous profiling and/or compilation is beneficial because such profiling and/or compilation may be computationally expensive. In some examples, a subsequent request for execution of a computation graph may arrive before compilation of the computation graph is complete. In such an example, the computation graph of the subsequent request may be executed using the interpretation mode (e.g., in the event that the compilation is not yet complete).

Returning to block 515, if the example graph executor 320 determines that the mode of operation for the computation graph should be the compilation mode e.g. the computation graph had been previously compiled into GPU instructions, the example GPU compiler interface 350 requests execution of the compile GPU instructions. (Block 570). In examples disclosed herein, the GPU compiler interface 350 interfaces with the example privileged instruction executor 214 via the IPC client 360 to request execution of the compiled GPU instructions. The example GPU compiler interface 350 then accesses a result of execution of the compiled GPU instructions via the IPC client 360. (Block 575). The result of the execution is then provided to the graph executor 320 so that the result (e.g., the output tensor) can further be provided to the example script engine. (Block 580). Control then returns to block 540 where the example graph profiler 340 profiles execution of the computation graph to determine whether to compile the GPU instructions. In some examples, after profiling the computation graph, the example graph profiler 340 may determine that the computation graph is no longer frequently executed (e.g., block 545 may return a result of NO), in which case the graph profiler 340 may update the mode of operation for the graph to return the computation graph to being executed using the interpretation mode.

In contrast to prior approaches for execution of machine learning workloads at a GPU, where individual nodes of a computation graph were provided to the GPU for individual execution, in the illustrated example of FIG. 5 the computation graph is identified to the privilege instruction executor 214 as a complete unit. Such an approach reduces the IPC communications overhead associated with providing intermediate results back and forth between the unprivileged instruction executor 212 and the privileged instruction executor 214.

FIG. 6 is a flowchart representative of machine readable instructions which may be executed to implement the example privileged instruction executor 214 of FIGS. 2 and/or 4 to compile a computation graph for execution by the graphics processing unit (GPU) 237 of FIG. 2. The example process 555 of FIG. 6 begins when the IPC server 410 accesses an indication of a computation graph to be compiled received from the unprivileged instruction executor 212. (Block 610).

The example IPC server 410 interacts with the example request validator 430 to determine whether the computation graph is valid. (Block 630). In examples disclosed herein the request validator 430 determines whether the computation graph and/or, more generally the request to compile the computation graph received from the example unprivileged instruction executor 212 is valid based on additional parameters provided in the indication of the computation graph to be compiled. In some examples, the additional parameters may include, for example, a certificate parameter indicating that the request is valid. However, any other approach to validating a request from the unprivileged instruction executor 212 may additionally or alternatively be used.

If the example request validator 430 determines that the request is not valid (e.g., block 630 returns a result of not valid), the example IPC server 410 indicates an invalidity of the request to compile the computation graph to the unprivileged instruction executor. (Block 640). In such an example, the GPU compiler interface 350 of the example unprivileged instruction executor does not record that the compilation mode should be used upon subsequent requests to execute the computation graph. The example process 555 of the illustrated example of FIG. 6 then terminates, but may be repeated, upon subsequent receipt of a request to compile a computation graph.

Returning to block 630, if the example request validator 430 determines that the request for compilation of the computation graph is valid (e.g., block 630 returns a result of VALID), the example GPU compilation orchestrator 420 loads GPU source code corresponding to each of the nodes of the computation graph. (Block 650). That is, the example GPU compilation orchestrator 420 constructs a GPU source code based on the operations that are to be performed as part of the connotation graph. In examples disclosed herein, the source code is retrieved from the optimized GPU code data store 440. Moreover, the optimized GPU code data store 440 stores optimized GPU code that, for example, enables utilization of hardware specific instructions and/or extensions. For example, hardware-specific features such as, Intel Open Computing Language (OpenCL) extensions, may be utilized on the instructions stored in the optimized GPU code data store 440.

The example GPU compilation orchestrator 420 sends the source code for compilation into a GPU-specific kernel (e.g., binary code) to the GPU driver. (Block 660). The example GPU driver 227 then compiles the GPU source code into GPU-specific kernel (e.g., binary code), and sto22res the GPU-specific kernel in the GPU instruction database 229. During the compilation, the example GPU compilation orchestrator 420 awaits completion of the compilation. (Block 670).

The example GPU compilation orchestrator 420 provides an indication of the completion of the compilation to the graph executor 320 via the IPC server 410. (Block 680). The graph executor 320 then marks the computation graph is compiled and switches to GPU compilation mode for subsequent executions of the computation graph (see block 560 of FIG. 5). The example process of FIG. 6 then terminates, but may be repeated upon subsequent request to compile a computation graph.

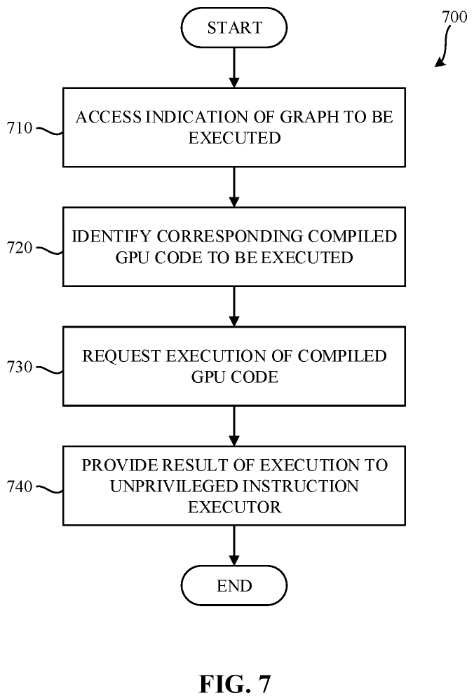

FIG. 7 is a flowchart representative of machine readable instructions which may be executed to implement the example privileged instruction executor of FIGS. 2 and/or 3 to provide compiled instructions to the GPU of FIG. 2 for execution. The example process 700 of FIG. 7 begins when the example IPC server 410 accesses a request for a compiled computation graph to be executed. (Block 710). In examples disclosed herein, the request is parsed to identify additional parameters (e.g., input data), a name of the computation graph to be executed, etc. In some examples, the IPC server 410 provides the request to the validator 430 for validation. The example IPC server 410 provides the request to the GPU compilation orchestrator 420, which identifies the corresponding kernel (e.g., compiled GPU-specific binary code) to be executed by the GPU 237. (Block 720). In examples disclosed herein, the corresponding kernel may be identified based on, for example, the name and/or other identifier of the computation graph to be executed.

The example GPU compilation orchestrator 420 requests execution of the kernel by the GPU 237. (Block 730). After the execution of the kernel completes, the result (e.g., the output tensor) is provided to the unprivileged instruction executor 212 (e.g., via the IPC communication channel 225). (Block 740). The example process 700 of FIG. 7 then terminates, but may be repeated upon a subsequent request to execute a compiled computation graph.

FIG. 8 is a block diagram of an example processor platform 800 structured to execute the instructions of FIGS. 5, 6, and/or 7 to implement the example unprivileged instruction executor 212 and/or privileged instruction executor 214 of FIGS. 2, 3, and/or 4. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example inter-process communication channel 225, the example GPU driver 227, the example script engine 310, the example graph executor 320, the example CPU interpreter 330, the example graph profiler 340, the example GPU compiler interface 350, the example IPC 360, the example IPC server 410, the example GPU compilation orchestrator 420, and the example request validator 430.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-plane switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The processor platform 800 of the illustrated example includes a graphics processing unit (GPU) 237 in communication via the bus 818.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 5, 6, and/or 7 may be stored in the mass storage device 828, in the volatile memory 814, in the non-volatile memory 816, and/or on a removable non-transitory computer readable storage medium such as a CD or DVD.

From the foregoing, it will be appreciated that example methods, apparatus and articles of manufacture have been disclosed that enable efficient execution of computation graphs using CPUs and GPUs. The disclosed methods, apparatus and articles of manufacture improve the efficiency of using a computing device by enabling interpreted execution of computation graphs on a CPU using optimized CPU instructions, as well as enabling a transition over to executing compiled GPU instructions that are compiled using GPU-specific source code. For example, by utilizing optimized CPU instructions (e.g., using AVX instructions), CPU Interpreter execution is about 3.5× faster than existing WebAssembly execution. Moreover, by utilizing optimized GPU operation implementation (e.g., Intel OpenCL extensions), GPU Compiler execution is about 4X faster than WebGL execution. Furthermore, while GPU execution starts slower than CPU execution (due to overhead associated with compiling GPU instructions and communicating such computation graph via IPC), using approaches disclosed herein enables a more controlled switch to utilization of a GPU compiler for better-sustained performance. The disclosed methods, apparatus and articles of manufacture are accordingly directed to one or more improvement(s) in the functioning of a computer.

Example 1 includes an apparatus for processing a machine learning model in a multi-process web browser environment, the apparatus including a graph executor to determine a mode of operation for a computation graph to be executed, a central processing unit (CPU) interpreter to lookup a CPU instruction corresponding to a node of the computation graph, the CPU instruction being a CPU-specific instruction for execution by at least one processor, a graph profiler to determine whether the computation graph is frequently executed, and a graphics processing unit (GPU) compiler interface to, in response to determining that the computation graph is frequently executed, transmit a request for compilation of at least two nodes of the computation graph into a GPU kernel for execution at a GPU.

Example 2 includes the apparatus of example 1, wherein the GPU compiler interface is to transmit a request for execution of the GPU kernel.

Example 3 includes the apparatus of example 1, wherein the GPU compiler interface is further to update the mode of operation for the computation graph, and the graph executor is to determine that the computation graph is to be executed using a compilation mode in response to the updating of the mode of operation for the computation graph.

Example 4 includes the apparatus of example 3, further including a request validator to, in response to the request for compilation of the computation graph, validate the request to compile the computation graph into the GPU kernel.

Example 5 includes the apparatus of example 4, further including a GPU compilation orchestrator to, in response to the request validator validating the request, identify GPU source code corresponding to the node of the computation graph, and compile the GPU source code into the kernel.

Example 6 includes the apparatus of example 5, wherein the GPU source code is a GPU-specific instruction for execution by the GPU.

Example 7 includes the apparatus of example 6, wherein the GPU-specific instruction is an open compute language instruction.

Example 8 includes the apparatus of example 1, wherein the CPU-specific instruction is an advanced vector extension instruction.

Example 9 includes at least one non-transitory computer readable medium comprising instructions which, when executed, cause at least one processor to at least determine a mode of operation for a computation graph to be executed, in response to determining that the computation graph is to be executed using an interpretation mode, perform a lookup of a central processing unit (CPU) instruction corresponding to a node of the computation graph, the CPU instruction being a CPU-specific instruction for execution by the at least one processor, profile execution of the computation graph to determine whether the computation graph is frequently executed, and in response to determining that the computation graph is frequently executed transmit a request for compilation of the computation graph into a graphics processing unit (GPU) kernel for execution at a GPU, and update the mode of operation for the computation graph.

Example 10 includes the at least one non-transitory computer readable medium of example 9, wherein the instructions, when executed, further cause the CPU instruction to be executed by the at least one processor.

Example 11 includes the at least one non-transitory computer readable medium of example 9, wherein the instructions, when executed, further cause the at least one processor to, in response to determining that the computation graph is to be executed using a compilation mode, transmit a request for execution of the GPU kernel.

Example 12 includes the at least one non-transitory computer readable medium of example 11, wherein the instructions, when executed, further cause the at least one processor to transmit the request for the execution of the GPU kernel to a privileged instruction executor.

Example 13 includes the at least one non-transitory computer readable medium of example 11, wherein the instructions, when executed, further cause the at least one processor to transmit the request for the execution of the GPU kernel via an inter-process communication channel.

Example 14 includes the at least one non-transitory computer readable medium of example 9, wherein the instructions, when executed, further cause the at least one processor to validate the request for compilation of the computation graph, in response to the validating of the request, identify GPU source code corresponding to the node of the computation graph, and compile the GPU source code into the kernel.

Example 15 includes the at least one non-transitory computer readable medium of example 14, wherein the GPU source code is a GPU-specific instruction for execution by the GPU.

Example 16 includes the at least one non-transitory computer readable medium of example 15, wherein the GPU-specific instruction is an open compute language instruction.

Example 17 includes the at least one non-transitory computer readable medium of example 9, wherein the CPU-specific instruction is an advanced vector extension instruction.

Example 18 includes an apparatus for processing a machine learning model in a multi-process web browser environment, the apparatus including means for determining a mode of operation for a computation graph to be executed, means for identifying a CPU instruction corresponding to a node of the computation graph, the CPU instruction being a CPU-specific instruction for execution by at least one processor, means for profiling to determine whether the computation graph is frequently executed, and means for transmitting, in response to determining that the computation graph is frequently executed, a request for compilation of the computation graph into a GPU kernel for execution at a GPU.

Example 19 includes the apparatus of example 18, wherein the means for transmitting is to transmit a request for execution of the GPU kernel.

Example 20 includes the apparatus of example 18, wherein the means for transmitting is further to update the mode of operation for the computation graph, and the means for determining is to determine that the computation graph is to be executed using a compilation mode in response to the updating of the mode of operation for the computation graph.

Example 21 includes the apparatus of example 20, further including means for validating, in response to the request for compilation of the computation graph, the request to compile the computation graph into the GPU kernel.

Example 22 includes the apparatus of example 21, further including means for selecting, in response to the means for validating validating the request, GPU source code corresponding to the node of the computation graph, and compiling the GPU source code into the kernel.

Example 23 includes a method of processing a machine learning model in a multi-process web browser environment, the method including determining, by executing an instruction with at least one processor, a mode of operation for a computation graph to be executed, and in response to determining that the computation graph is to be executed using an interpretation mode performing a lookup of a central processing unit (CPU) instruction corresponding to a node of the computation graph, the CPU instruction being a CPU-specific instruction for execution by the at least one processor, profiling execution of the computation graph to determine whether the computation graph is frequently executed, and in response to determining that the computation graph is frequently executed, compiling the computation graph into a graphics processing unit (GPU) kernel for execution at a GPU, and updating the mode of operation for the computation graph.

Example 24 includes the method of example 23, further including causing the CPU instruction to be executed by the at least one processor.

Example 25 includes the method of example 23, further including, in response to determining that the computation graph is to be executed using a compilation mode, transmitting a request for execution of the GPU kernel.

Example 26 includes the method of example 25, wherein the determining that the computation graph is to be executed using the compilation mode is performed in response to the updating of the mode of operation for the computation graph.

Example 27 includes the method of example 25, wherein the request for the execution of the GPU kernel is transmitted to a privileged instruction executor.

Example 28 includes the method of example 25, wherein the request for the execution of the GPU kernel is transmitted via an inter-process communication channel.

Example 29 includes the method of example 23, wherein the compiling of the computation graph into the GPU kernel includes accessing a request to compile the computation graph into the GPU kernel, validating the request, in response to the validating of the request, identifying GPU source code corresponding to the node of the computation graph, and compiling the GPU source code into the kernel.

Example 30 includes the method of example 29, wherein the GPU source code is a GPU-specific instruction for execution by the GPU.

Example 31 includes the method of example 30, wherein the GPU-specific instruction is an open compute language instruction.

Example 32 includes the method of example 23, wherein the CPU-specific instruction is an advanced vector extension instruction.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus for processing a machine learning model in a multi-process web browser environment, the apparatus including:
a graph executor to determine a mode of operation for a computation graph to be executed;
a central processing unit (CPU) interpreter to lookup a CPU instruction corresponding to a node of the computation graph, the CPU instruction being a CPU-specific instruction for execution by at least one processor;
a graph profiler to determine whether the computation graph is frequently executed; and
a graphics processing unit (GPU) compiler interface to, in response to determining that the computation graph is frequently executed, transmit a request for compilation of at least two nodes of the computation graph into a GPU kernel for execution at a GPU.

2. The apparatus of claim 1, wherein the GPU compiler interface is to transmit a request for execution of the GPU kernel.

3. The apparatus of claim 1, wherein the GPU compiler interface is further to update the mode of operation for the computation graph, and the graph executor is to determine that the computation graph is to be executed using a compilation mode in response to the updating of the mode of operation for the computation graph.

4. The apparatus of claim 3, further including a request validator to, in response to the request for compilation of the computation graph, validate the request to compile the computation graph into the GPU kernel.

5. The apparatus of claim 4, further including a GPU compilation orchestrator to, in response to the request validator validating the request, identify GPU source code corresponding to the node of the computation graph, and compile the GPU source code into the kernel.

6. The apparatus of claim 5, wherein the GPU source code is a GPU-specific instruction for execution by the GPU.

7. The apparatus of claim 6, wherein the GPU-specific instruction is an Open Compute Language instruction.

8. The apparatus of claim 1, wherein the CPU-specific instruction is an advanced vector extension instruction.

9. At least one non-transitory computer readable medium comprising instructions which, when executed, cause at least one processor to at least:
determine a mode of operation for a computation graph to be executed; in response to determining that the computation graph is to be executed using an interpretation mode, perform a lookup of a central processing unit (CPU) instruction corresponding to a node of the computation graph, the CPU instruction being a CPU-specific instruction for execution by the at least one processor;
profile execution of the computation graph to determine whether the computation graph is frequently executed; and
in response to determining that the computation graph is frequently executed:
transmit a request for compilation of the computation graph into a graphics processing unit (GPU) kernel for execution at a GPU; and
update the mode of operation for the computation graph.

10. The at least one non-transitory computer readable medium of claim 9, wherein the instructions, when executed, further cause the CPU instruction to be executed by the at least one processor.

11. The at least one non-transitory computer readable medium of claim 9, wherein the instructions, when executed, further cause the at least one processor to, in response to determining that the computation graph is to be executed using a compilation mode, transmit a request for execution of the GPU kernel.

12. The at least one non-transitory computer readable medium of claim 11, wherein the instructions, when executed, further cause the at least one processor to transmit the request for the execution of the GPU kernel to a privileged instruction executor.

13. The at least one non-transitory computer readable medium of claim 11, wherein the instructions, when executed, further cause the at least one processor to transmit the request for the execution of the GPU kernel via an inter-process communication channel

14. The at least one non-transitory computer readable medium of claim 9, wherein the instructions, when executed, further cause the at least one processor to:
validate the request for compilation of the computation graph;
in response to the validating of the request, identify GPU source code corresponding to the node of the computation graph; and
compile the GPU source code into the kernel.

15. The at least one non-transitory computer readable medium of claim 14, wherein the GPU source code is a GPU-specific instruction for execution by the GPU.

16. The at least one non-transitory computer readable medium of claim 15, wherein the GPU-specific instruction is an Open Compute Language instruction.

17. The at least one non-transitory computer readable medium of claim 9, wherein the CPU-specific instruction is an advanced vector extension instruction.

18. An apparatus for processing a machine learning model in a multi-process web browser environment, the apparatus including:
means for determining a mode of operation for a computation graph to be executed;
means for identifying a CPU instruction corresponding to a node of the computation graph, the CPU instruction being a CPU-specific instruction for execution by at least one processor;
means for profiling to determine whether the computation graph is frequently executed; and
means for transmitting, in response to determining that the computation graph is frequently executed, a request for compilation of the computation graph into a GPU kernel for execution at a GPU.

19. The apparatus of claim 18, wherein the means for transmitting is to transmit a request for execution of the GPU kernel.

20. The apparatus of claim 18, wherein the means for transmitting is further to update the mode of operation for the computation graph, and the means for determining is to determine that the computation graph is to be executed using a compilation mode in response to the updating of the mode of operation for the computation graph.

21-32. (canceled)
